(19) United States
(12) Patent Application Publication
(10) Pub. No.: US 2010/0103276 A1
(43) Pub. Date: Apr. 29, 2010

(54) SPLIT APERTURE CAPTURE OF RANGEMAP FOR 3D IMAGING

(76) Inventor: John N. Border, Walworth, NY (US)

Correspondence Address: Pedro P. Hernandez;Patent Legal Staff, Eastman Kodak Company, 343 State Street, Rochester, NY, 14650-2201, US

(21) Appl. No.: 12/259,348

(22) Filed: Oct. 28, 2008

(51) Int. Cl. H04N 5/228; G06T 15/00

(52) U.S. Cl. 348/222.1; 345/419; 348/E05.031

(57) ABSTRACT

An image capture system that can capture images as well as rangemaps, includes a split aperture device having a first and a second states and used to capture one or more image pairs that includes a first image captured during the first state and a second image captured during the second state. The image capture system also includes a rangemap generator coupled to the split aperture device, the rangemap generator generates a rangemap by comparing local image shifts between the first image and the second image. A method is also described for capturing of rangemap information for 3D imaging.

### FIELD OF THE INVENTION

The present invention relates generally to image capture and more specifically to an image capture system for producing a rangemap for 3 dimensional (3D) imaging.

### BACKGROUND OF THE INVENTION

In 3D imaging the image capture system must include some method for obtaining the distance to the objects in the scene. This can be done by various means including ultrasonic time of flight; light based time of flight; projecting a pattern; or triangulation.

Ultrasonic time of flight is described in U.S. Pat. No. 4,331,409. Motion sensors and other electronic devices affect ultrasonic systems and they also do not work through windows. So they are not well suited for consumer based imaging systems. A light based time of flight system is described in U.S. Pat. No. 6,057,909. While this type of system will operate through a window, the high power consumption of the infrared illumination system limits its use to non-portable imaging systems.

A system that projects a pattern onto the scene is described in U.S. Pat. No. 5,666,566. This system also suffers from high power consumption since an illumination source must be used that is bright enough to illuminate the entire scene. Triangulation systems are often used for autofocus systems such as the rangefinder module described in U.S. Pat. No. 4,606,630. However, autofocus rangefinder modules of this type use a very limited field of view with limited focusing data output so that they are not suited to 3D imaging. In addition, the accuracy and repeatability of distance measurements provided by autofocus rangefinder modules are typically influenced by environmental factors due dimensional shifts in the plastic components.

A split color filter system is another version of triangulation that can be used to produce a rangemap of a scene. In a split color filter system, a split color filter is inserted into the optical path of the lens at the aperture position thereby creating 2 optical paths with different perspectives. The split color filter is constructed so that the filter area is divided into at least two different areas with different colors (typically red and blue) in the different areas. Two images are then captured simultaneously as a first image overlaid on top of a second image, but since the first and the second images are different colors they can be differentiated in the overlaid image in areas where they do not overlap. A split color filter system for autofocus is described by Keiichi in Japanese Patent Application 20011174496.

Any defocus present in the image creates an offset between the two images from the different perspectives of the 2 optical paths, which then shows up as color fringes on either side of the object in the image. Movement of the focusing lens reduces or enlarges the color fringes in the image depending on the distance from focus. When the image is well focused, the color fringes disappear. Defocus inside of the focal point causes the fringes to be one color on one side and the other color on the other side of the object in the image. Defocus outside of the focal plane results in the colors of the color fringes being reversed. Consequently, with this approach, one image taken with the split color filter delivers an autofocus image that can be analyzed to determine the degree of defocus and the direction of defocus. However, the introduction of the color filter into the optical path makes the technique unsuitable for colored image capture.

Another technique that can be used to produce a rangemap is the split aperture approach. In the case of the split aperture approach, the aperture in the lens is alternately partially blocked over at least two different portions of the aperture, to create two or more optical paths. Because the two optical paths in the split aperture device do not have different colors, the split aperture device requires that two images be captured with different partial aperture blocking. The difference in perspective between the two optical paths causes the two images to be offset laterally in proportion to the degree of defocus and direction of defocus for an object in the image. A split aperture system for autofocus is described in United States Patent Publication No. 2008/0002959, entitled “Autofocusing Still and Video Images”. In this patent application, the aperture is alternately partially blocked thereby creating two optical paths. Autofocus images are alternately captured for both optical paths in combination with video images in which the aperture is not blocked. Due to the partially blocked aperture, regions of the autofocus images are shifted laterally when compared one to another in proportion to the distance from focus. Thus, a comparison of two sequential autofocus images with different partial aperture blocking enables the lateral offsets between images to be identified and the related distance from focus to be calculated for identifiable objects in the scene. However, the split aperture system described in United States Patent Publication No. 2008/0002959 is limited to autofocus use. In view of the above, a need persists for a method of image capture that can generate a rangemap suitable for use with 3D imaging.

### SUMMARY OF THE INVENTION

It is an object of the present invention to provide a method for capturing images along with rangemaps of the scene that is suitable for use in generating 3D images. This object is achieved in one embodiment by the use of a split aperture imaging system that captures images with the aperture partially blocked so that rangemaps can be generated along with still or video images for display or storage. Embodiments are presented for RGB sensors and RGBP sensors. In some embodiments, images are captured specifically for creating rangemaps while other images are captured specifically for creating images for display or storage. In still other embodiments, images are used to create rangemaps and the same images are used to create images for display or storage. The rangermaps can be stored with the images for display or storage so that they can be used to create a 3D file, a 3D print or a 3D display. An image capture system that produces images for display or storage as well as rangemaps is also described.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings. In the drawings, structures or steps are shown with the same number where they have similar functions or meanings.

FIG. 1 is a schematic diagram of a split aperture imaging system;

FIGS. 2A and 2B are illustrations of the two states of a mechanical split aperture device;

FIGS. 3A and 3B are illustrations of the two states of a liquid crystal split aperture device;

FIG. 4A is an illustration of a portion of the color filter array for an RGB sensor;

FIG. 4B is an illustration of a portion of the color filter array for an RGBP sensor;

FIG. 5 is a block diagram of a split aperture system for embodiment of the method of the invention;

FIG. 6A is a flowchart for an embodiment of the method of the invention;

FIG. 6B is a flowchart for another embodiment of the method of the invention;

FIG. 7A is an image captured with the split aperture device in a first state;

FIG. 7B is an image captured with the split aperture device in a second state;

FIG. 7C is an image captured with the split aperture device in a first state and in a second state; and

FIG. 8 is a flowchart for a further embodiment of the method of the invention.

### DETAILED DESCRIPTION OF THE INVENTION

A split aperture system suitable for use with the method of an embodiment of the invention is described in United States Patent Publication No. 2008/0002959, which hereby incorporated by reference as if fully set forth herein. The split aperture system provides two different perspectives to the image capture system so that images can be captured from the different perspectives as the aperture is partially blocked in different ways. The images in the image pairs are compared to determine local offsets or image shifts between edges of objects in the images which correspond to distances from the focal plane that the split aperture system lens is focused on and a rangemap can be formed showing the distances from the image capture device to the objects in the scene.

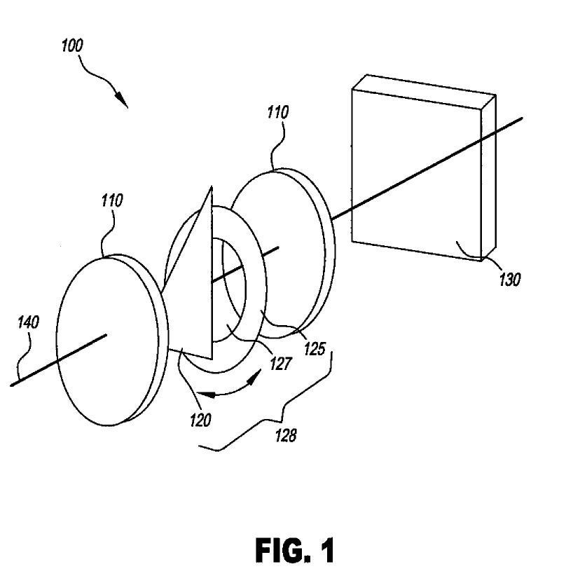

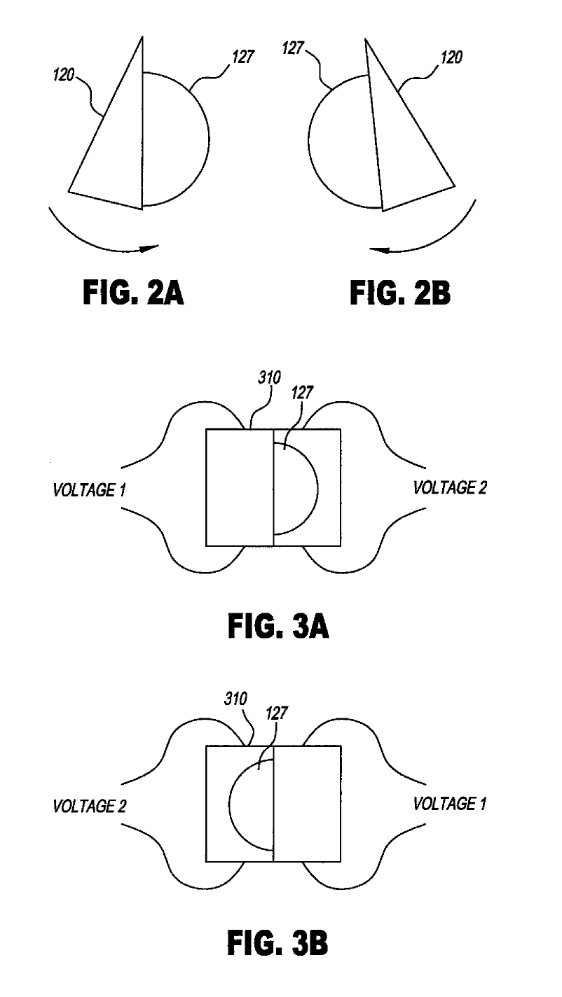

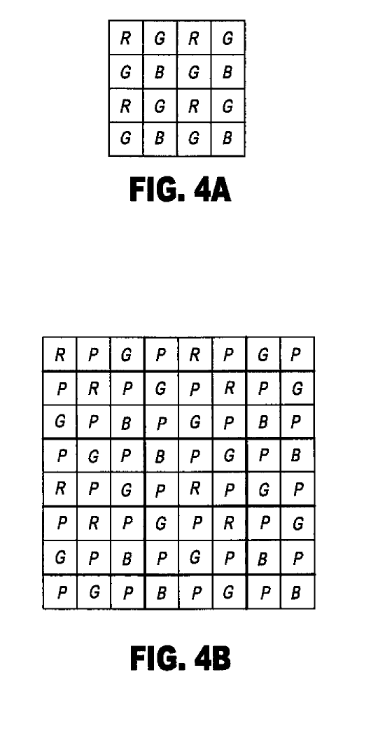

A schematic diagram of a split aperture imaging system 100 is shown in FIG. 1. The split aperture imaging system 100 is comprised of a lens assembly 110, a split aperture device 128 and an image sensor 130. Wherein the lens assembly 110, the aperture stop 127 and the image sensor 130 share a common optical axis 140. The lens assembly 110 can be a fixed focal length lens or a variable focal length (zoom) lens. The split aperture device 128 is comprised of a half aperture blocker 120, an aperture 127 and an aperture stop 125. The split aperture device 128 has two conditions or states, where in the first condition or state, a first half of the aperture is substantially blocked by the half aperture blocker 120 and a second half of the aperture is substantially unblocked, and in the second state, the first half of the aperture is substantially unblocked and the second half of the aperture is substantially blocked by the half aperture blocker 120. By using a half aperture blocker 120 that blocks approximately ½ of the aperture 127 at a time, the perspectives of the images captured when the split aperture device is in the first state compared to the images captured when the split aperture device is in the second state are separated by approximately 0.4× the diameter of the aperture of the lens. The half aperture blocker 120 can be a rotating mechanical device, a sliding mechanical device or a solid-state device such as a two-pixel liquid crystal device. FIGS. 2A and 2B show a mechanical half aperture blocker 120 in the two conditions or states relative to the aperture 127. In FIG. 2A a first portion of aperture 127 is blocked by half aperture blocker 120 while in FIG. 2B the other half of the aperture 127 is blocked. In another embodiment as shown in FIGS. 3A and 3B a two pixel liquid crystal device 310 is used as a half aperture blocker in the two states relative to the aperture 127 where the level of an applied voltage causes the pixels in the liquid crystal device to be alternately clear or opaque. In general, any electromechanical device that can alternately substantially block the two halves of the aperture at a rate that is suitable for capture of video as described previously should be considered within the scope of the invention including rotational devices, ferroelectric devices, electrochromic devices and tilting devices such as blockers and mirrors.

Table 1 below shows data on image shifts produced with a split aperture imaging system 100 by objects in the image at different positions relative to the hyperfocal distance for lenses of different focal lengths.

TABLE 1

| | | | | | | On axis image | Delta image |
|---|---|---|---|---|---|---|---|
| | | | | | | shift left to | shift from |
| | | Effective F- | | Focus | Defocus | right blocker | hyperfocal |
| focus setting | Length [mm] | number | Object distance [mm] | Condition | zones | (mm) | (mm) |
| wide-hyperfocal | 5.5 | f/2.81 | 1365 | in-focus | 0 | 0.0011 | 0.0000 |
| wide-hyperfocal | 5.5 | f/2.81 | infinity | out of focus | 1 | −0.0012 | −0.0023 |
| wide-hyperfocal | 5.5 | f/2.81 | 343 | out of focus | −2 | 0.0048 | 0.0038 |
| mid-hyperfocal | 13.0 | f/4.44 | 4891 | in-focus | 0 | 0.0008 | 0.0000 |
| mid-hyperfocal | 13.0 | f/4.44 | infinity | out of focus | 1 | −0.0019 | −0.0027 |
| mid-hyperfocal | 13.0 | f/4.44 | 1228 | out of focus | −2 | 0.0072 | 0.0064 |
| tele-hyperfocal | 21.8 | f/5.14 | 11229 | in-focus | 0 | 0.0004 | 0.0000 |
| tele-hyperfocal | 21.8 | f/5.14 | infinity | out of focus | 1 | −0.0025 | −0.0029 |
| tele-hyperfocal | 21.8 | f/5.14 | 2815 | out of focus | −2 | 0.0075 | 0.0072 |

Wherein the hyperfocal distance is the focus distance where the depth of field of a lens is the largest and objects at infinity are just in focus. The different focal lengths shown in Table 1 are meant to show the effect of focal length and f# as would be seen for different image capture devices with fixed focal length lenses of different focal lengths or as would be seen with a zoom lens as the lens is moved through the zoom range. The data in Table 1 shows that split aperture systems 100 with longer focal length lenses produce larger image shifts, when the split aperture device 128 is moved from a first state to a second state, for objects that are located the same number of defocus zones away from the hyperfocal distance for the lens. As can be seen from the data, larger image shifts are seen for longer focal length lenses even with the increasing f#'s shown for the longer focal length lenses. Higher f#'s are shown for the longer focal length lenses in Table 1 as would be typical for simple zoom lenses. Hence, for an image sensor that has 0.0014 mm pixels, for a 5.5 mm focal length lens focused at 1365 mm, an object at 1365 mm shows a 0 pixel image shift when the split aperture device 128 is moved between the first and second states, while an object at infinity shows an image shift of approximately 2 pixels when the split aperture device 128 is moved between the first and second states. For the same image sensor, an object at 343 mm is substantially out of focus and the object shows an image shift of approximately 3 pixels when the split aperture device 128 is moved from the first state to the second state. Objects at other distances would show more or less image shift depending on how close they are located to the focus setting of the lens when the split aperture device 128 is moved from the first state to the second state.

In addition, for a given focal length, smaller higher f#'s as produced by stopping down the iris will reduce the size of the aperture and subsequently reduce the resolution produced by the split aperture device. Consequently, changes in f# such as may be produced by an autoexposure system will affect the image shifts produced by the split aperture device 128 and this effect should be take into account when converting the image shift data to a rangemap.

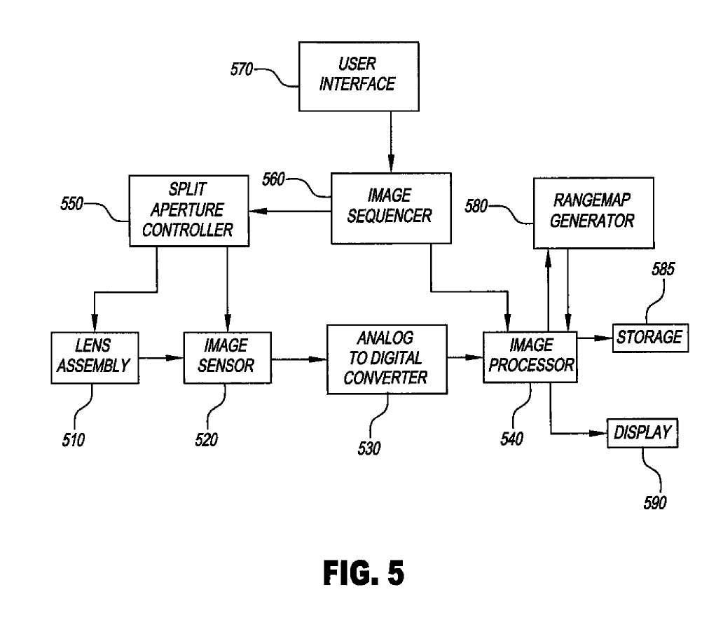

FIGS. 4A and 4B show the pixel arrangements (color filter arrays) for two types of image sensors that are used in digital image capture devices such as digital cameras. FIG. 4A shows a pixel arrangement for an RGB image sensor that detects red, green and blue light within the image as provided by the lens assembly. FIG. 4B shows a pixel arrangement for an RGBP image sensor that detects red, green, blue and panchromatic light within the image as provided by the lens assembly. Wherein the red, green and blue pixels detect light within their respective portions of the visible light spectrum and panchromatic pixels detect light from substantially all the visible spectrum. It should be noted that the pixel arrangements shown in FIGS. 4A and 4B are for example only, and the invention is equally applicable to other pixel arrangements and other types of pixels such as cyan, magenta, yellow, ultraviolet or infrared pixels within the scope of the invention.

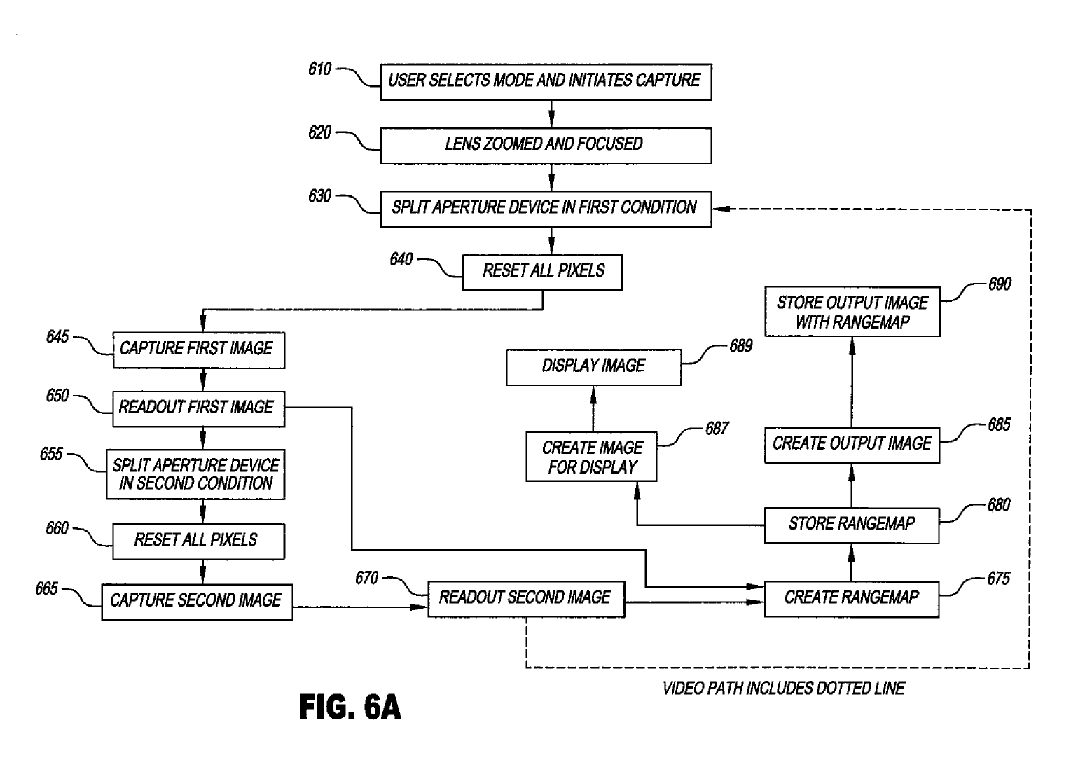

The present invention discloses a split aperture imaging system that can be used to capture images and generate rangemaps wherein output images are linked or associated with rangemaps before being stored or transmitted to other devices so that the output images can be subsequently rendered for 3D images in a 3D image file, a 3D display or a 3D print. FIG. 5 shows a block diagram of an image capture device including a split aperture imaging system that can be used to capture images and generate rangemaps. The lens assembly 510 includes a lens 110, a split aperture device 128, along with other lens components for imaging such as a focusing system, an exposure meter, and an iris. A split aperture controller 550 controls the movement of the half aperture blocker 120 or 310 between two states. The lens assembly 510 gathers light from a scene and forms an image on the image sensor 520. An image set comprised of multiple images is captured by the image sensor 520 and converted from analog to digital signals in the analog to digital converter 530 and the resulting image data is sent to an image processor 540. The image processor 540 processes the image data to improve the image quality, correct imaging artifacts and arranges the output image in the form requested by the user through mode selection and other imaging options on the user interface 570. The image sequencer 560 controls the order of capture of the multiple images in the image set. A rangemap is generated from the image data by the rangemap generator 580. The rangemap can be used by the image processor 540 to further improve the images. The image processor 540 creates an image for display on display 590 and an output image that is stored with the rangemap in storage 585. The invention can be used for both still and video images, wherein a single image set is captured to form a 3D still image and multiple images sets are captured continuously over the length of time of the video to form a series of images for a 3D video.

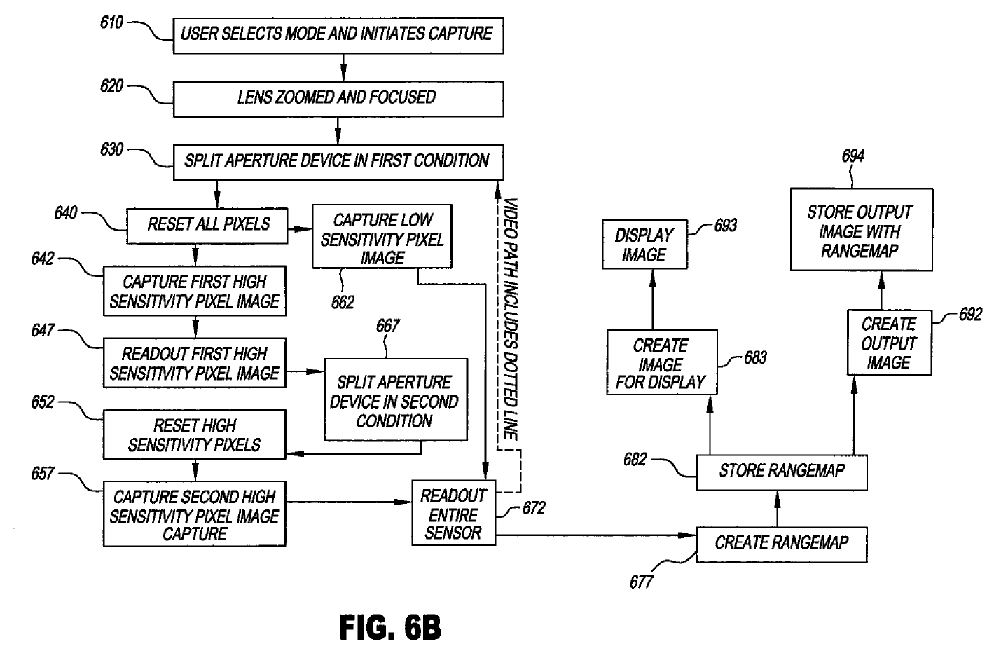

FIG. 6A shows a flow chart for an embodiment of the method of the invention where the image set is comprised of image pairs which are captured with alternating states of the split aperture device 128. This embodiment can be practiced with a split aperture imaging system 100 that has either an RGB image sensor or an RGBP image sensor. In this embodiment the images captured in the image pairs include substantially all of the pixels of the image sensor. A rangemap is generated by comparing the two images in the image set to one another to identify regional or local offsets between the two images due to different locations of objects in the scene and detected by the differences in perspective provided by the alternating states of the split aperture device. The methods used to generate the rangemaps are known to those of ordinary skill in the art such as those described in United States Patent Publication 2008/0002959.

In 610, the user selects a mode of operation and initiates capture through the user interface 570. The lens is zoomed and focused in 620 to prepare for capture of the image set(s). In 630, the split aperture device 128 is put into a first state. The pixels are then all reset in 640 and a first image is captured in 645. The first image is readout in 650 and temporarily stored. The split aperture device 128 is then put into a second state in 655. All the pixels are reset in 660 and a second image is captured in 665 and readout in 670 and temporarily stored. A rangemap is then generated in 675 by the rangemap generator 580 by comparing the first and second images to identify regional offsets between the images. The rangemap is then stored in 680. The image processor 540 then uses the image data and the rangemap to create an image for display in 687 and an output image in 685, wherein the image for display and the output image can be the same image or different images. The image for display is then displayed in 689 such as on the display 590 on the image capture device or another display. The output image and the rangemap are then stored in 690 in the storage 585 so that they are associated or linked together for subsequent rendering into a 3D file, 3D display or 3D print. For a still image, the process moves through the steps shown in FIG. 6A once. For a video, the process loops through the steps shown in FIG. 6A with 670 and 630 being connected with the dotted line shown in FIG. 6A so that images sets are sequentially captured and rangermaps, display images and output images are continuously generated through the time period of the video capture.

In one embodiment of the invention, both the image(s) for display and the output image(s) can be formed in 687 and 685 respectively by merging the first and second images within an image set to create a full image. In this way, the images for display and the output images combine the perspectives produced by the split aperture device being in the first state and the second state. In this way, one merged full image can be formed from each image set which for the case of video capture produces an output image frame rate that is ½ that of the frame rate of the alternating capture of first and second images. In a further embodiment of the invention, full images for display and output images are formed by merging the last available first and second images, either within the same image set or between sequential image sets, to form full images at the same frame rate as the alternating capture of first and second images.

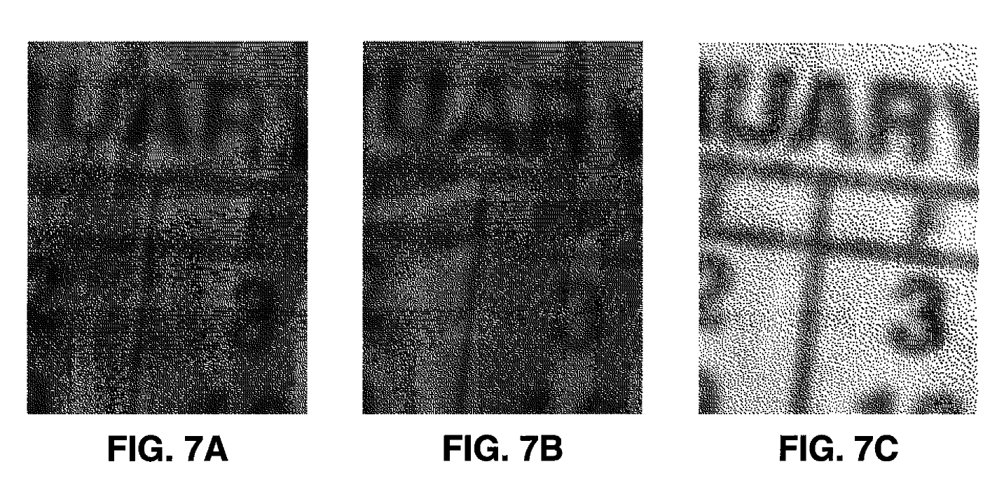

FIG. 7A shows an illustration of an image captured with the split aperture device in a first state. FIG. 7B shows an illustration of an image captured with the split aperture device in a second state. Visual comparison of the images in FIGS. 7A and 7B shows that the image in FIG. 7B is offset slightly to the left compared to the image in FIG. 7A. This offset corresponds to the distance from the image capture device to the region of the scene shown in the images. In contrast, FIG. 7C shows an illustration of an image formed by merging the image in FIG. 7A with the image in FIG. 7B wherein the offset between the two images contributes to a blurrier image with wider features. In addition, since the image shown in FIG. 7C has an exposure time that is equivalent to the added exposure time of the image in FIG. 7A and FIG. 7B, the image shown in FIG. 7C is approximately twice as bright. Wherein the exposure time is the difference in time between when the pixels in the image have been reset and the time when the image has been readout or if the image capture device has a shutter, it is the time the shutter is open. In a yet further preferred embodiment, the first and second images are aligned prior to being merged to compensate for motion of the split aperture device during the capture of the image set. The alignment can be accomplished by correlating the first and second images to one another or by gathering independent information about the movement of the split aperture device such as with a gyro sensor to identify the amount the first and second images must be shifted to obtain the best alignment prior to merging.

FIG. 6B shows a flowchart for another embodiment of the method of the invention. This embodiment requires the use of an RGBP image sensor or other image sensor which has some pixels distributed in a sparse array that have higher sensitivity to light from the scene such as the panchromatic pixels in the RGBP image sensor. In this embodiment, the image set is comprised of 2 panchromatic images and 1 red, green, blue (RGB) image. The panchromatic images have an exposure time that is ½ or less that of the RGB image and the panchromatic images are exposed sequentially with only one state of the split aperture device during the exposure of each panchromatic image, while the RGB image is exposed sequentially to each of the two states of the split aperture device. In this way, the panchromatic images are captured with different perspectives as caused by the half aperture blocker being in different states while the RGB image is captured with both perspectives.

In FIG. 6B, 610, 620, 630 and 640 are the same as previously described for FIG. 6A. After all the pixels have been reset in 640, the exposure time begins simultaneously for the capture of both a first high sensitivity pixel (panchromatic) image in 642 and a low sensitivity pixel (RGB) image in Step 662 with the split aperture device 128 in a first state. The first high sensitivity pixel image is readout in 647 thereby interrupting the exposure of the high sensitivity pixels. The split aperture device 128 is then put into a second state in 667. The high sensitivity pixels are then reset in 652 beginning the exposure time for a second high sensitivity pixel image to be captured in 657 while the exposure of the RGB pixels continues uninterrupted. In 672, the exposure time for both the second high sensitivity pixel image and the low sensitivity pixel image are ended when the entire sensor is readout. For a still image, the image set comprised of a first high sensitivity pixel image, a second high sensitivity pixel image and a low sensitivity pixel image proceeds on to 677. For a video, the current image set proceeds on to 677 while the capture process returns to 630 following the dotted line shown in FIG. 6B for the capture of the next image set. In 677 the first high sensitivity pixel image and the second high sensitivity pixel image are compared to create a rangemap which is stored in 682. An image for display is then created from the image set by the image processor 540 in 683 and an output image is created in 692. The image for display is then displayed in 693 while the output image is stored with the rangemap in 694.

In a further embodiment of the invention, the image(s) for display and the output image(s) are formed in 683 directly from the low sensitivity pixel images, and the first and second high sensitivity pixel images are used just to create rangemaps as in 677.

In another embodiment, the first and second high sensitivity pixel images are used to create rangemaps in 677 and then they are merged together to form high sensitivity pixel image(s) as shown for example by the illustrations in FIGS. 7A, 7B and 7C and discussed previously. The single high sensitivity images then can be used in conjunction with the low sensitivity image(s) in the image processor 540 to produce improved image(s) for display and improved output image(s). Methods of producing images from combined low sensitivity pixel images and high sensitivity pixel images are described in U.S. patent application Ser. No. 11/780,523 filed Jul. 20, 2007 by John F. Hamilton Jr., et al. which is incorporated by reference as if fully set forth herein.

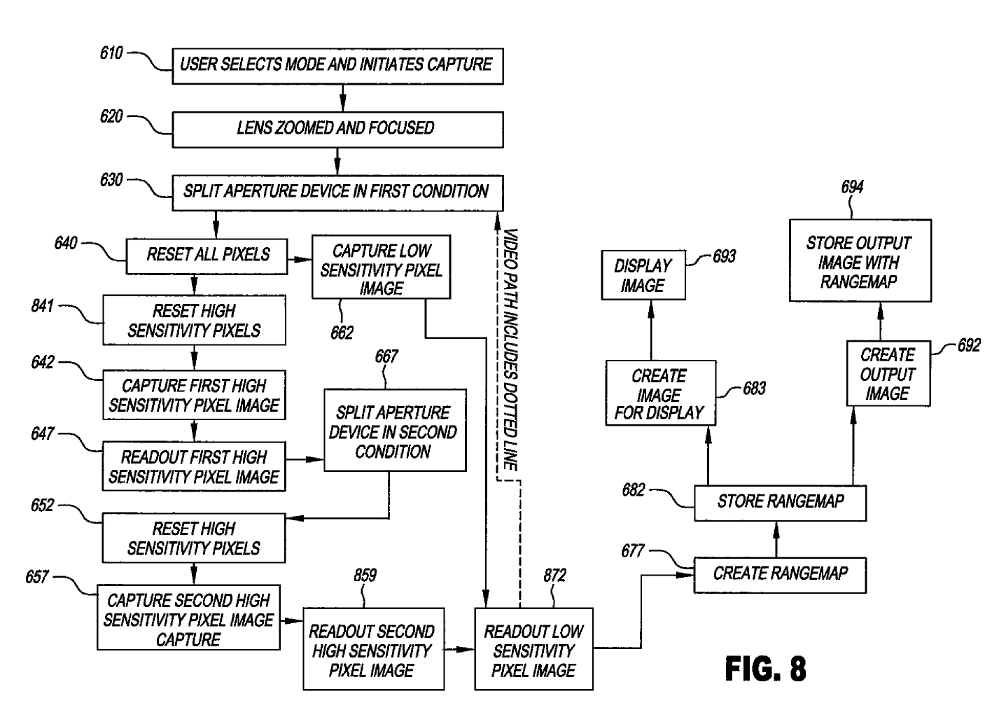

In yet another embodiment, the exposure times of the high sensitivity pixel images are controlled independently from the low sensitivity pixel image exposure times. The flow chart for this process is shown in FIG. 8. In this process, the high sensitivity pixels are reset in 841 that occurs after the exposure time for the low sensitivity pixel image has begun in 662. A readout of the second high sensitivity pixel image is done in 859 and the readout of the low sensitivity image is done at a later time in 872. The other steps in the flow chart of FIG. 8 are the same as presented in FIG. 6 and discussed previously. This approach provides a separate and selectable time for starting the exposure of the first high sensitivity pixel image (as when the high sensitivity pixels are reset in 841 compared to the start of the exposure for the low sensitivity pixel image that begins with the reset of all the pixels in 640. Likewise, the approach provides a separate and selectable time for the end of the exposure for the second high sensitivity pixel image in 859 (where the second high sensitivity pixel image is readout) compared to the end of the exposure for the low sensitivity pixel image which ends with the readout of the low sensitivity pixel image in 872. By adding procedures 841 and 859, the timing of the capture of the first and second high sensitivity pixel images and the exposure times for the first and second high sensitivity pixels images can be selected to be different from the timing of the capture and the exposure time for the low sensitivity pixel images.

In a preferred embodiment, the timing of the capture of the first and second high sensitivity pixel images is centered in the middle of the exposure time for the low sensitivity pixel images. In addition, in 652 (reset of the high sensitivity pixels) occurs substantially immediately after in 647 (readout of the first high sensitivity pixel image). Further, the exposure times for the first and second high sensitivity pixel images are less than ½ the exposure time of the low sensitivity pixel image. The advantage provided by this embodiment is that motion effects that cause differences between the first and second high sensitivity pixel images are reduced which improves the accuracy of the rangemap when objects in the scene are moving and makes the alignment of the images in the image set easier.

In a further preferred embodiment based on the flowchart shown in FIG. 6A, the rangemap created in 675 is created line by line during the readout of the second image in 670. This is done by comparing the lines being readout from the second image to corresponding lines from the first image as the second image is being readout. The advantage of this embodiment is that the size of the buffers required to produce the rangemap are reduced.

In yet another preferred embodiment based on the flowchart shown in FIG. 8, the rangemap generated in 675 is generated line by line during the readout of the second high sensitivity pixel image in 859. This is done by comparing the lines being readout from the second high sensitivity pixel image, to corresponding lines from the first high sensitivity pixel image, as the second high sensitivity pixel image is being readout. The advantage of this embodiment is that the size of the buffers required to produce the rangemap are reduced.

The invention has been described in detail with particular reference to certain preferred embodiments thereof, but it will be understood that variations and modifications can be effected within the spirit and scope of the invention.

### PARTS LIST

100 Split aperture imaging system
110 Lens assembly
120 Half aperture blocker
125 Aperture stop
127 Aperture
128 Split aperture device
130 Image sensor
140 Optical axis
310 Two pixel liquid crystal device
510 Step
520 Step
530 Step
540 Step
550 Step
560 Step
570 Step
580 Step
585 Step
590 Step
610 Step
620 Step
630 Step
640 Step
642 Step
645 Step
647 Step
650 Step
652 Step
655 Step
657 Step
660 Step
662 Step
665 Step
667 Step
670 Step
672 Step
675 Step
677 Step
680 Step
683 Step
685 Step
687 Step
689 Step
690 Step
692 Step
693 Step
694 Step
841 Step
859 Step
872 Step

1. An image capture system that can capture images as well as rangemaps, comprising:
a split aperture device having a first and a second state and used to capture one or more image pairs that include a first image captured during the first state and a second image captured during the second state; and
a rangemap generator coupled to the split aperture device, the rangemap generator generates a rangemap by comparing local image shifts between the first image and the second image.

2. An image capture system as defined in claim 1, further comprising:
an image processor for merging the first and second images in order to form a full image.

3. An image capture system as defined in claim 1, further comprising:
an image processor for merging the first and second images in the one or more image pairs to generate a video with ½ the frame rate that the first and second images are captured at.

4. An image capture system as defined in claim 1, further comprising:
an image processor for merging the last available first and second images from the same or different image pairs to generate a video with a frame rate that is the same as the frame rate that the first and second images are captured at.

5. An image capture system as defined in claim 1, further comprising:
a sensor that includes pixels with high sensitivity and pixels with low sensitivity coupled to the image processor.

6. An image capture system as defined in claim 5, further comprising:
a sensor that includes color pixels and panchromatic pixels coupled to the image processor.

7. An image capture system as defined in claim 5, wherein images comprised of high sensitivity pixels can be captured separately from images comprised of low sensitivity pixels.

8. An image capture system as defined in claim 5 wherein high sensitivity pixel images and low sensitivity pixel images can be simultaneously captured with different exposure times.

9. An image capture system as defined in claim 5 wherein the high sensitivity pixel images are used to create rangemaps.

10. An image capture system as defined in claim 9, wherein the low sensitivity pixel images are used to create an image for display or storage.

11. An image capture system as defined in claim 1, wherein the split aperture device includes an electromechanical half aperture blocker.

12. An image capture system as defined in claim 2, wherein the fill image is used with the rangemap to create a 3D image file, a 3D print or a 3D display.

13. An image capture system as defined in claim 5, wherein two high sensitivity pixel images are captured during the time that each low sensitivity pixel image is captured.

14. An image capture system as defined in claim 1, wherein the split aperture device includes a liquid crystal half aperture blocker.

15. An image capture system as defined in claim 10, wherein the image for display or storage is used with the rangemap to create a 3D image file or a 3D display.

16. A method for capturing images as well as rangemaps using an image capture device, comprising:
capturing one or more image pairs using a split aperture device that captures a first image during a first state and a second image during a second state; and
generating a rangemap by comparing local image shifts between the first image and the second image.

17. A method as defined in claim 16, further comprising: merging the first and second images in order to form a full image.

18. A method as defined in claim 17, wherein the full image is used with the rangemap to create a 3D image file, a 3D print or a 3D display.

19. A method as defined in claim 16, wherein the rangemap is generated line by line during the readout of the image pairs.

20. A method as defined in claim 16, wherein the capturing of one or more image pairs using a split aperture device includes using an electromechanical half aperture blocker.
